(19) United States
(12) Patent Application Publication
(10) Pub. No.: US 2009/0187494 A1
(43) Pub. Date: Jul. 23, 2009

(54) VIRTUAL INVENTORY SYSTEM

(76) Inventor: Susie V. Heath, Carmel, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/357,118

(22) Filed: Jan. 21, 2009

Related U.S. Application Data
(60) Provisional application No. 61/021,726, filed on Jan. 17, 2008.

(51) Int. Cl. G06Q 10/00; G06F 7/06; G06F 17/30

(52) U.S. Cl. 705/28; 707/4; 707/10; 707/E17.032; 707/E17.014

(57) ABSTRACT

A system and method are provided that allow a user to search for products within the inventory of multiple vendors. The disclosed web-based application allows a customer to maintain a virtual inventory. A web server is maintained separately from the customer's and vendor's computer system and the web server runs virtual inventory software. A database server is interfaced with the web server and the database server stores user settings specific to the user. A plurality of vendor inventory databases is interfaced with the web server. The web server is configured to receive a product search request from the user and search the plurality of inventory databases pursuant to the product search request

### REFERENCED TO RELATED APPLICATIONS

This patent application claims the benefit of U.S. Provisional Patent Application No. 61/021,726, filed Jan. 17, 2008, which is incorporated by reference herein in its entirety.

### TECHNICAL FIELD OF THE INVENTION

The present invention relates to a system and method for allowing customers to maintain a virtual inventory.

### BACKGROUND

The present invention relates to a system and method for allowing customers to quickly and efficiently search the inventories of third party vendors, or any other supplier of parts including internal inventory.

The increased use of computers and the growth of the internet have greatly affected business to business commerce. For example, a business may now consider whether or not to physically warehouse inventory. For many businesses it is no longer economically feasible to have a warehouse large enough to supply potential customer demand. There may not be enough business to turn over the inventory in a timely manner that would financially justify the rent paid for the warehouse space and the costs associated with housing and managing the inventory. Further, with the up and down nature of many businesses, a business may rent space to be used for inventory warehousing only for the same space to later go unused for a period of time when the inventory is sold. Thus, for many businesses, it is more cost effective to order the inventory from a vendor when a customer order is placed.

As another example, a business may consider whether or not to store replacement parts for use with internal business equipment. A large amount of money is often spent to warehouse such parts. In addition to the cost of purchasing the replacement part, the company must warehouse the part for later use. In this situation, it may be cost effective to order the part from a supplier when it is needed. In both contexts, by maintaining a “virtual inventory” that is actually warehoused by a third party vendor, businesses have a much larger available inventory to offer to their clients.

Currently, direct contact with each and every individual vendor is one way to maintain such a virtual inventory. When an item is requested by a customer, the retailer must quickly locate and purchase the item. It may take a considerable amount of time to perform a successful search. Internet searching provides great potential in this regard, though many drawbacks to such a system exist. Internet searches may not provide the data the retailer needs, such as the number of units available, price, and location. Though this may not be of much relevance to the individual consumer purchasing a single item, retail customers often buy many units to fulfill orders for their customers or to stock their stores. It is therefore important that the retail customer be aware of the number of items available for purchase. Location of the part is also important because of its relationship to shipping time.

Nevertheless, internet searches are of value in the event that the inventories of the third party vendors do not contain the item of interest. In that case, a system should provide a seamless transition from inventory searching to global, internet searching. The system must accurately and efficiently relay the product found on the internet to the person capable of ordering the item through direct contact with the vendor or other internet purchasing systems.

Due to a shift in inventory warehousing, many businesses appreciate a service that allows for the fast and efficient searching and utilization of a third party vendor's inventory. Likewise, vendors would be willing to participate in such a service if that meant quicker and more complete turnover of the inventory maintained.

Thus, there is a need for a system comprising a web-based application that links a client with potential vendors in order to provide an inventory locator service. Such a system gives the client complete control over the administration of the system, such as the ability to adjust the pricing terms, multipliers, email addresses, login information, and passwords, to name a few details.

There is also a need for a system that performs an integrated internet search to provide the client with an additional search option if a match is not found in the vendor's inventory.

### SUMMARY

The present invention provides an improved system and method for maintaining virtual inventory. The claims, and only the claims, define the invention.

In accordance with one aspect of the present invention, a system is provided for the searching of products from the inventory an associated vendor by a user. The system comprises a computer system associated with particular user and a web server communicatively connected to the user computer system. The web server is maintained separately from the user computer system and web serving runs virtual inventory software. A database server is interfaced with the web server and the database server stores user settings specific to the user. A plurality of vendor inventory databases is interfaced with the web server. The user must be logged into the web server via an internet connection to access the virtual inventory software. The web server is configured to receive a product search request from the user and search the plurality of inventory databases pursuant to the product search request.

One object of the present invention is to provide a system and method for maintaining a virtual inventory that overcomes the shortcomings of the prior art devices.

Further, objectives and advantages of the present invention will appear as the description proceeds.

### DESCRIPTION OF THE DRAWINGS

FIG. 1 is a block diagram illustrating one embodiment of a virtual inventory system of the present invention.

FIG. 2 is a schematic flow chart of a home page and linked pages cascading therefrom according to one embodiment of the invention.

FIG. 3 is an exemplary screen shot of the Home page illustrated in FIG. 2 according to one embodiment of the invention.

FIG. 4 is an exemplary screen shot of the Log In page illustrated in FIG. 2 according to one embodiment of the invention.

FIG. 5 is an exemplary screen shot of the Product Search page illustrated in FIG. 2 according to one embodiment of the invention.

FIG. 6 is an exemplary screen shot of the System Search Results page illustrated in FIG. 2 according to one embodiment of the invention.

FIG. 7 is an exemplary screen shot of the Inventory Details page illustrated in FIG. 2 according to one embodiment of the invention.

FIG. 8 is an exemplary screen shot of the Enter Quote page illustrated in FIG. 2 according to one embodiment of the invention.

FIG. 9 is an exemplary screen shot of the Enter Order page illustrated in FIG. 2 according to one embodiment of the invention.

FIG. 10 is an exemplary screen shot of the Global Search Results page illustrated in FIG. 2 according to one embodiment of the invention.

FIG. 11 is an exemplary screen shot of the Find Quote page illustrated in FIG. 2 according to one embodiment of the invention.

FIG. 12 is an exemplary screen shot of the Find Quote Results page illustrated in FIG. 2 according to one embodiment of the invention.

FIG. 13 is an exemplary screen shot of the Find Order page illustrated in FIG. 2 according to one embodiment of the invention.

FIG. 14 is an exemplary screen shot of the Find Order Results page illustrated in FIG. 2 according to one embodiment of the invention.

FIG. 15 is an exemplary screen shot of the Find by Customer page illustrated in FIG. 2 according to one embodiment of the invention.

FIG. 16 is an exemplary screen shot of the Find by Customer Results page illustrated in FIG. 2 according to one embodiment of the invention.

FIG. 17 is an exemplary screen shot of the Administration page illustrated in FIG. 2 according to one embodiment of the invention.

FIG. 18 is an exemplary screen shot of the User Administration page illustrated in FIG. 2 according to one embodiment of the invention.

FIG. 19 is an exemplary screen shot of the User Maintenance page illustrated in FIG. 2 according to one embodiment of the invention.

FIG. 20 is an exemplary screen shot of the Configuration Administration page illustrated in FIG. 2 according to one embodiment of the invention.

FIG. 21 is an exemplary screen shot of the Configuration Maintenance page illustrated in FIG. 2 according to one embodiment of the invention.

FIG. 22 is an exemplary screen shot of the Reports page illustrated in FIG. 2 according to one embodiment of the invention.

### SUMMARY OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the inventions as illustrated therein being contemplated as would normally occur to one skilled in the art to which the invention relates.

One embodiment of the present invention includes a system that provides a web-based application that links a client with vendors' inventories to provide an inventory locator service, or virtual inventory system. The inventory locator service is provided over the internet and maintained separately from the client's computer system.

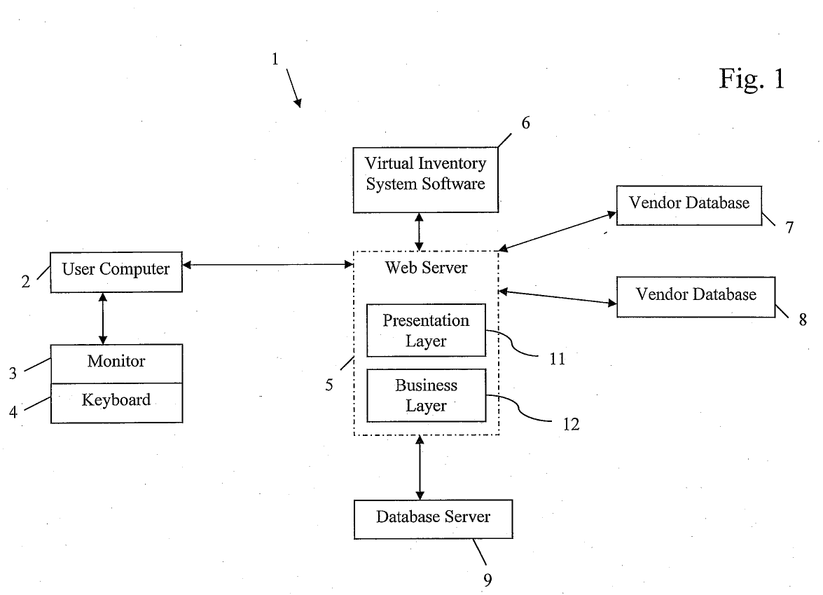

FIG. 1 illustrates a virtual inventory system 1 of one embodiment of the present invention. For the purposes of this application, a “User” is the person utilizing virtual inventory system 1 on behalf of a business/entity in order to locate inventory items of third party vendors. According to the illustrated embodiment, the User has a computer 2, a monitor 3, and a keyboard 4. The User's computer 2 is independently connected to a web server 5 via an internet connection. Web server 5 runs a virtual inventory system software 6. The virtual inventory system software 6 is run independently from User computer 2. In order for the User to access the virtual inventory system software 6, the User computer 2 must be logged into the web server 5 via an internet browser. While FIG. 1 illustrates the User logging into the web server 5 through the use of a computer 2, the disclosed system can be utilized by any device having internet capability, such as a cell phone or PDA.

As illustrated, virtual inventory system 1 also includes a vendor inventory database 7 and a vendor inventory database 8. In other embodiments, virtual inventory system 1 includes additional vendor inventory databases. Web server 5 is also interfaced with vendor inventory databases 7 and 8 in order to allow searching of these inventories. In practice, a business or User and vendor agree to the manner or way in which web server 5 searches vendor inventory databases 7 and 8. For example, the User or business may agree that web server 5 searches vendor inventory database 7 through an XML connection, while web server 5 fetches batch files from vendor inventory database 8. Optimally, the interface between web server 5 and vendor inventory databases 7and 8 creates a data structure that facilitates as close to real-time data searching as possible. As will be appreciated, while only a limited number of user computers 2 and vendor inventory databases 7 and 8 are illustrated, it is contemplated that multiple user computers can be simultaneously interfaced with web server 5 and that web server 5 can simultaneously query multiple vendor inventory databases.

Also interfaced with the web server 5 is a database server 9. Database server 9 allows for storage of the various user settings, previous quotes, previous orders, and other user specific information. Particularly, database server 9 will dictate which vendor inventory databases 7 and 8 to search when a query is initiated by user computer 2. For example, if vendor database 7 is associated with a particular user and vendor database 8 is not, database server 9 would instruct web server 5 to only search vendor database 7. As a result, virtual inventory system 1 allows for only relevant vendor inventory databases to be searched. The data corresponding to the found parts is returned to web server 5 to be displayed to the User on user computer 2. However, web server 5 does not store the part information; it is merely temporarily located on the web server 5 to allow the User to view the part data. In one embodiment, database server 9 runs on an SQL server and web server 5 runs on IIS utilizing the .net framework. In one embodiment, the application logic of virtual inventory system software 6 is developed using C# language.

As shown in FIG. 1, web server 5 includes a presentation layer 11 and a business layer 12. Presentation layer 11 contains the information to be utilized by the User, such as the web pages and inventory data fetched from the vendor inventory databases and viewed by the User. As will be discussed in more detail below, in one embodiment the Presentation layer 11 includes the Home page 10, Log In page 15, Product Search page 20, System Search Results page 22, Inventory Details page 23, Enter Quote page 24, Enter Order page 25, Global Search Results page 26, Find Quote page 30, Find Quote Results page 31, Find Order page 40, Find Order Results page 41, Find by Customer page 50, and Find by Customer Results page 51. It is important to note that presentation layer 11 is only available to potential Users. The third party vendors do not have access to the virtual inventory system 1, other than through the interface between the vendor inventory databases 7 and 8 and web server 5. Thus, vendor inventory databases 7 and 8 are unaware of each other or other vendors in the system. In contrast to presentation layer 11, business layer 12 includes all of the back-end support needed to run and host the system. In one embodiment, the back-end support includes the database server 9, connection to vendor inventory databases 7 and 8, hosting of the website, maintenance and support of the virtual inventory system software 6, maintenance and support of database server 9, and tuning database server 9. Generally speaking, business layer 12 includes all functions associated with the application, development, and support of the virtual inventory system 1.

In another embodiment, virtual inventory system 1 is integrated with an already pre-existing inventory tool utilized by a general retailer. In use, the general retailer representatives would be able to click a button on their own application, and a search would be run on the virtual inventory system 1. In this embodiment, there is no natural or direct connection between the retailer's inventory tool and virtual inventory system 1, because virtual inventory system 1 is a web-based application.

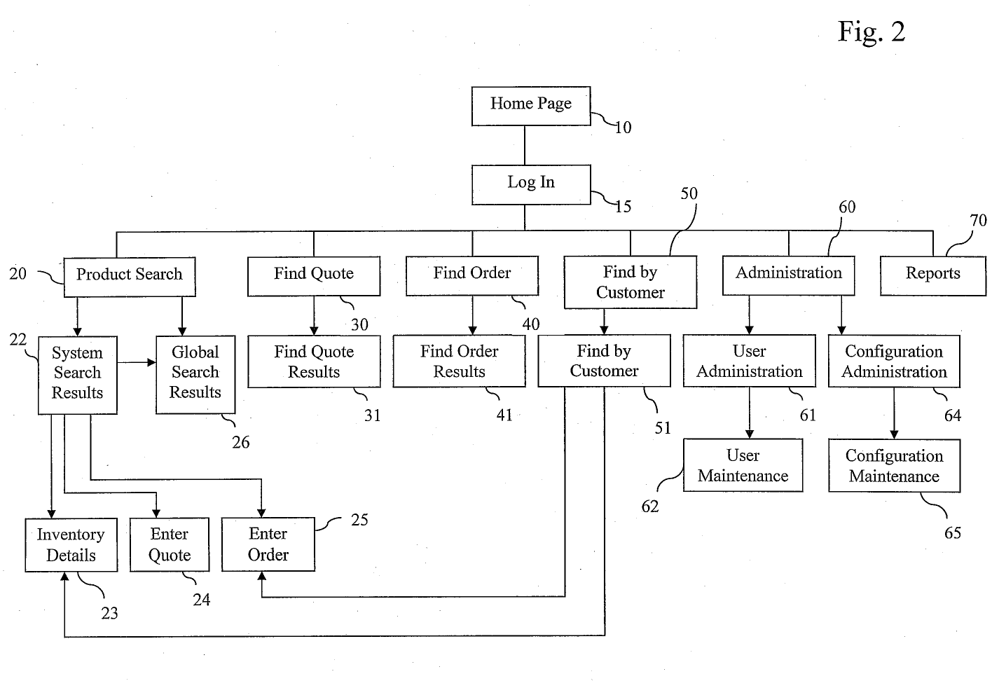

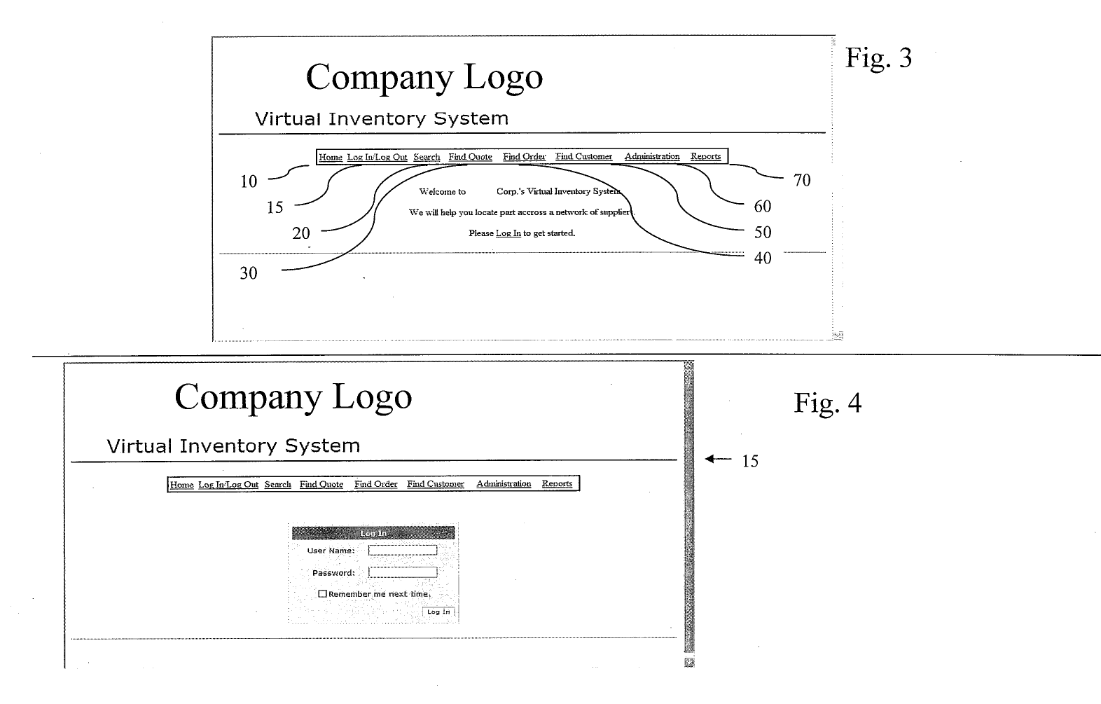

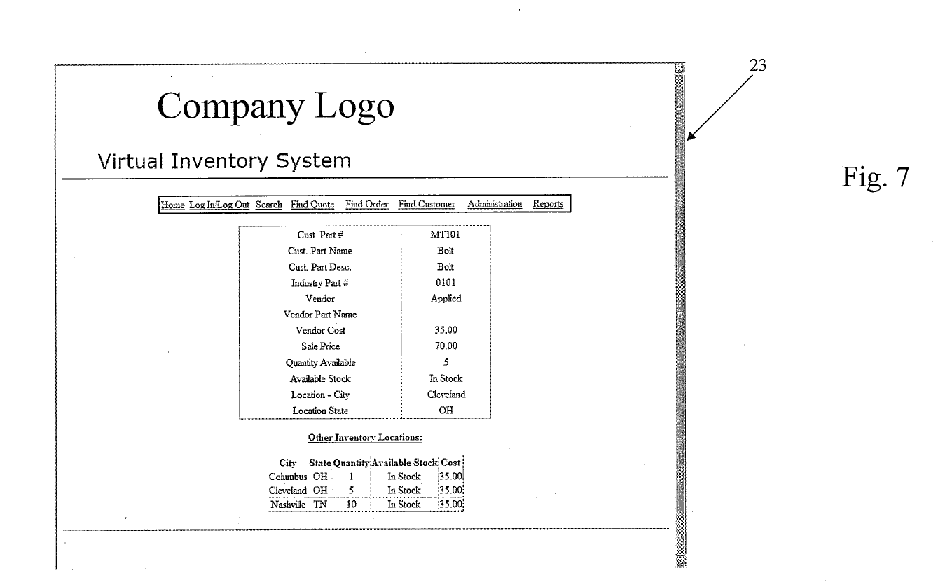

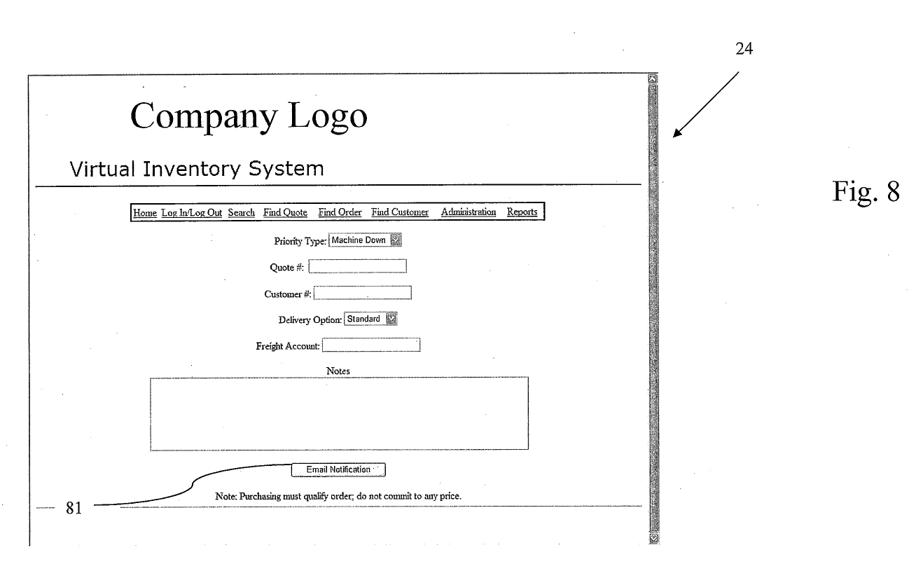

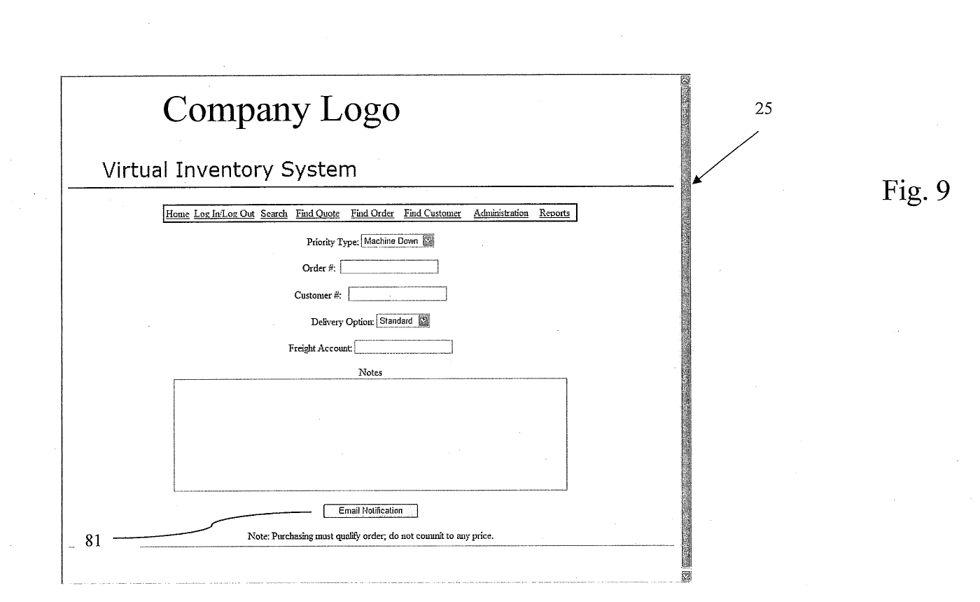

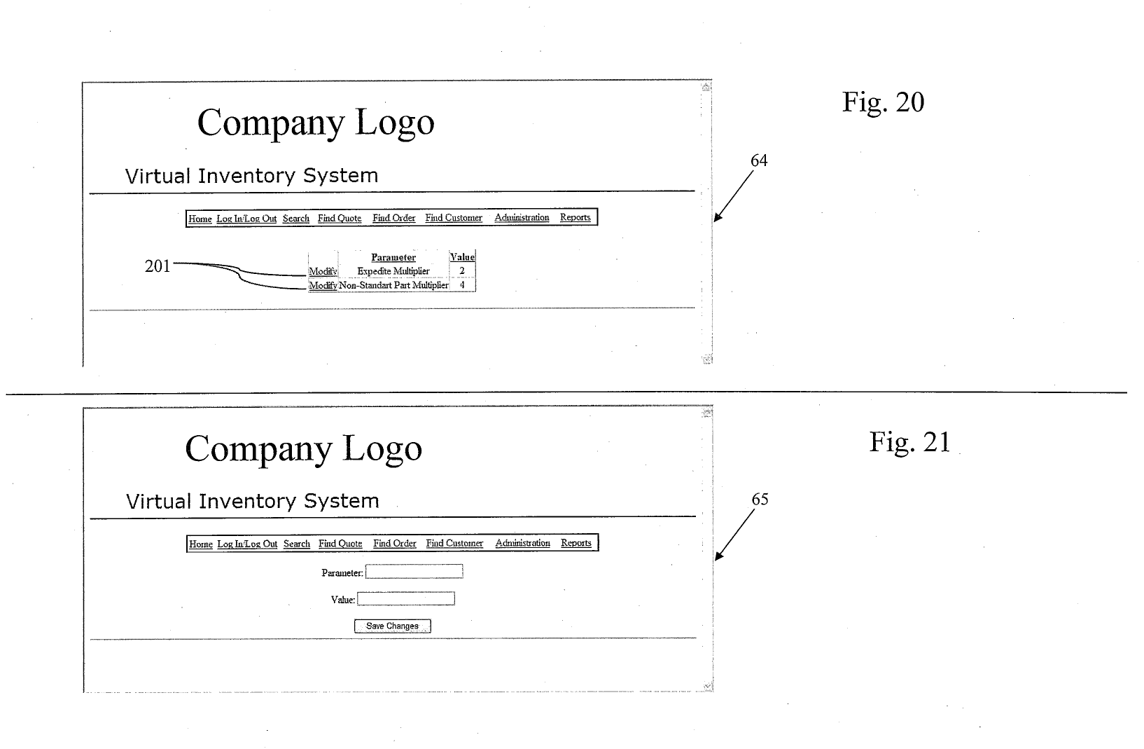

FIG. 2 is an overview of the website application and linked pages. FIGS. 3-22 depict screen shots of the various web-pages according to the illustrated embodiment. While the text of the illustrated web-pages is written in English, other languages are contemplated. Once connected to the internet, the user would enter home page 10, as shown in FIG. 3. The User would log in on Log In page 15 using the appropriate user name and unique password, as shown in FIG. 4. If the User provides the correct information, the User is then allowed to click and enter the various web-page options. If incorrect information is provided, then the User is instructed to try again.

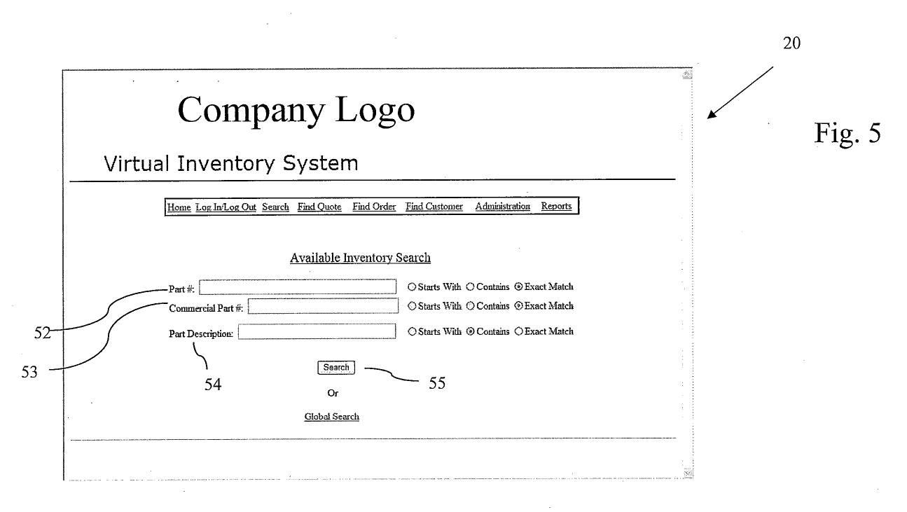

As shown in FIG. 3, after the User inputs the correct user name and password, various links will be made available in the page menu. As depicted, the company logo associated with the logged in User will appear in the upper portion of the web-page. One link available in the page menu is the Product Search page 20. After entering the Product Search page 20, the User will be able to perform an available inventory search based on a variety of criteria. As shown in FIG. 5, a product search can be performed based on part number 52, commercial part number 53, and/or part description 54. In one embodiment, if more than one field is populated, then all the fields are combined using an “and” operator. Further searching options are also considered. For example, for each search field the user can specify an exact match or a partial match, such as “starts with” or “contains.” The part number and commercial part number will default to an exact match, while the part description field defaults to the “contains” partial match. It should be noted that selecting “starts with” inserts a wild card at the end of the entered string, and selecting “contains” will insert a wildcard at the beginning and end of the entered string.

After the User has entered the desired search criteria, clicking Search button 55 executes a search of the relevant vendors' inventories in an attempt to locate available inventory. By clicking Search button 55, the virtual inventory system software 6 validates that at least one of the search fields is populated. If the page is not validated, a search command will not be sent to web server 5. The User is also notified that search criteria must be entered into at least one field. If the page is validated, then the search is initiated on web server 5. Once the results are determined, the User is directed to System Search Results page 22. Upon a validated search, the search parameters and the name of the user performing the search are stored in the database server 9 so that a report can later be generated on the number of searches being performed and the User who performed the search.

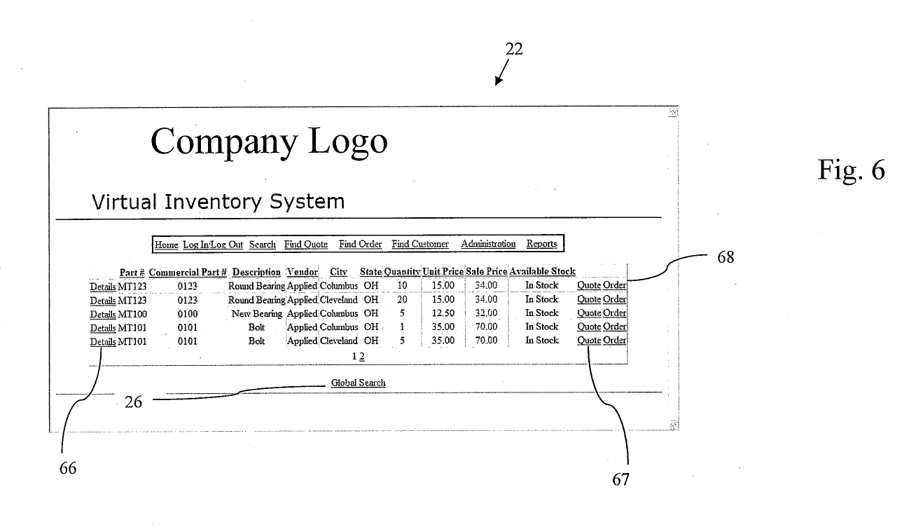

As shown in FIG. 6, the System Search Results page 22 displays the results of the User's search. The System Search Results page 22 can display any or all of the following: part number, commercial part number, partial part description, vendor, city and state of warehouse, quantity, unit price, sale price, available stock and/or additional information. If no available inventory is found, then a message is displayed notifying the User that no items are found and encouraging the User to perform a global, internet search.

In another embodiment, virtual inventory system software 6 provides a vendor hierarchy, industrial and/or regional intelligence. In this embodiment, a client Administrator indicates which vendor inventory databases to display when a User searches for particular commodities. The client Administrator may limit the vendor inventory databases that are searchable in order to render a particular vendor inventory database preferred. For example, the Administrator may limit vendor inventory databases because the vendor agrees to provide the commodity at a low cost if a certain number of parts are ordered. In this embodiment, the client Administrator would show only that particular vendor's inventory to the User in order to fill that requirement or order. In another form, the vendor hierarchy may allow a User to search the inventories of preferred and non-preferred vendors. As an example, those suppliers designated as preferred vendors may have agreements established with the User or provide better pricing to the User. However, the option to search non-preferred vendor inventories allows the User to search the inventory databases of suppliers with which the User has no relationship.

Regional intelligence may also be incorporated. As should be appreciated, the virtual inventory system 1 is offered as a web-based application; therefore, there are no physical or geographical limitations to the locations of the client companies or vendors. However, due to shipping costs or time concerns, a client company may wish to order a certain commodity from a particular region. Thus, vendor hierarchy, regional intelligence and/or industrial filters would give the client company more control over the virtual inventory system 1.

Various links are available on the System Search Results page 22. According to the illustrated embodiment, the System Search Results page 22 includes a Details link 66, a Quote link 67, and an Order link 68. Selection of the Details link 66 will display an Inventory Details page 23 of the selected item. The Inventory Details page 23 displays information about the selected part, as well as a listing of the selected location and other locations of the selected vendor with available inventory. Clicking on the Quote link 67 on the Search Results page 22 will pass the part information to an Enter Quote page 24, where the User is then prompted for a quote number and/or a customer number. Selecting the Order link 68 from the Search Results page 22 passes the part information to an Enter Order page 25 which prompts the user for an order number and/or a customer number. It is also contemplated that the virtual inventory software 6 can be set to automatically populate the order number and/or customer number to enable the User to quickly enter a quote or order.

On both the Enter Quote page 24 and Enter Order page 25, the User can enter other relevant information, such as priority type, delivery options, freight accounts, and notes. Also, both the Enter Quote page 24 and Enter Order page 25 contain an Email Notification button 81. After clicking the Email Notification button 81, the virtual inventory system software 6 can verify that the quote number and customer number fields are populated. After this is verified, an email containing the selected part and quote or order information is sent to the user or users indicated to receive this information as designated on the User Administration page 61. A copy of the email will also be sent to the User logged into the web server 5. The quote or order information is also stored in the database server 9 to give users quick access to previous quotes or orders.

In another form, the virtual inventory system software 6 allows for the “building” of quotes and orders. For example, a User may search for three different parts, but all the parts are associated with a particular client. By allowing the User to build the order, the ordering process would be more efficient because the person in charge of purchasing would only review a single order, instead of three separate orders.

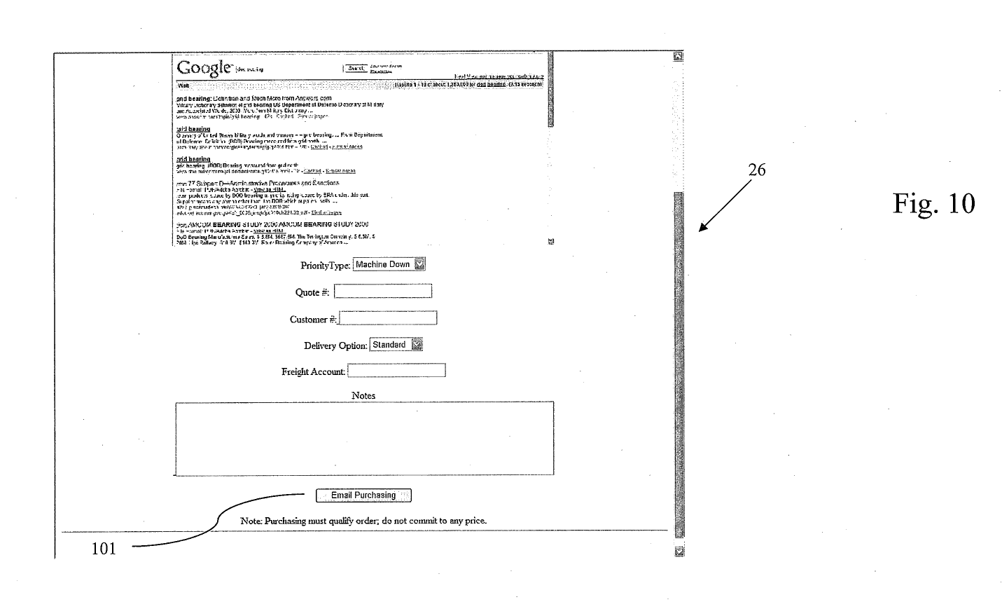

As previously indicated, a User has the option to perform a global, internet search. The results of such a search are displayed on Global Search Results page 26, as shown in FIG. 10. There are multiple ways to generate Global Search Results page 26. One way is to click the “Global Search” link on the Product Search page 20, and another way is from the System Search Results page 22. The global search allows the User to perform a search on a predetermined internet search engine. By selecting global search, the strings present in the search fields will be passed and incorporated into the internet search.

Reference is now made to FIG. 10. Once a product has been located on the Global Search Results page 26, additional fields can be populated, such as priority type, quote number, customer number, delivery options, freight accounts, and notes. At any time, the User can select an Email Purchasing button 101. Selection of the Email Purchasing button 101 sends an email containing the internet search results and the search criteria to the Global Search Administrator, as defined on a User Administration page 61. The Global Search Administrator can use the information contained in the email and attempt to obtain the part. A copy of the email will also be sent to the User logged into web server 5. In one embodiment, the search results may be saved so that a future User can quickly access a previous Global Search Results page 26.

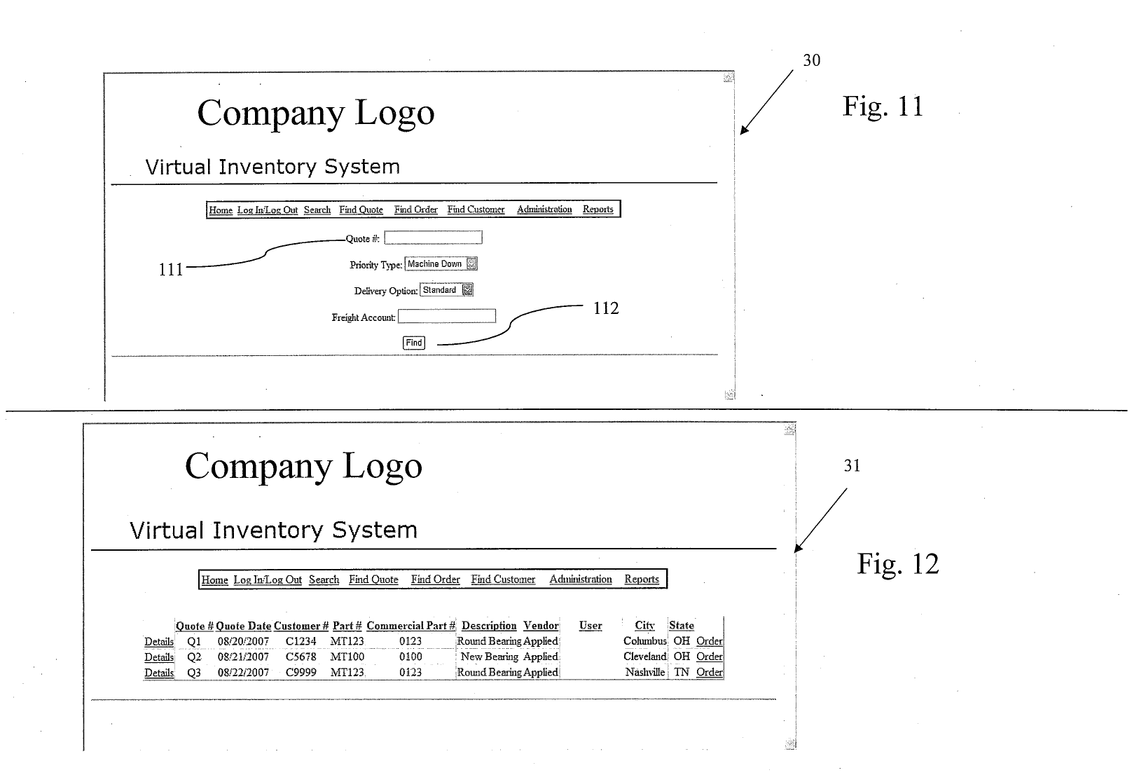

As shown in FIGS. 2 and 3, the virtual inventory system 1 gives a properly logged in user many options in addition to Product Search page 20. The User can enter the Find Quote page 30 to search for previously entered quotes. Referring now to FIG. 11, the User can enter strings into the desired search fields, such as a quote number field 111. By clicking a Find Quote button 112, the virtual inventory system software 6 will take the values from any or all of the search fields and combine them with an “and” operator to search previously entered quotes for any matches. The User is then redirected to the Find Quote Results page 31, shown in FIG. 12, where the User is presented with all of the previously recorded quotes matching the entered search criteria.

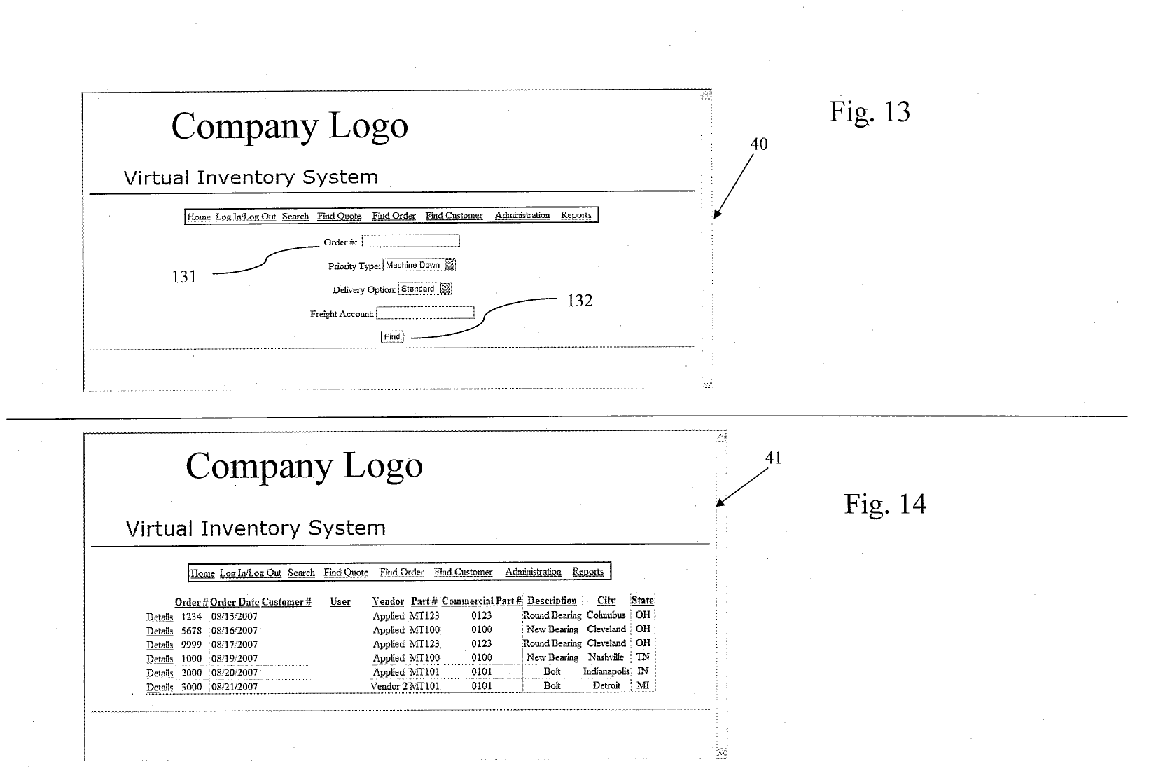

Referring to FIG. 13, a User also has the option to enter the Find Order page 40 to search for previously entered orders. After entering the Find Order page 40, the User can input strings into the desired search fields, such as an order number field 131. By clicking a Find Order button 132, the virtual inventory system software 6 will take the values from any or all of the search fields and combine them with an “and” operator to search for previously entered orders for any matches. The User is then redirected to the Find Order Results page 41, as shown in FIG. 14, where the User is presented with all of the previously recorded orders matching the entered search criteria.

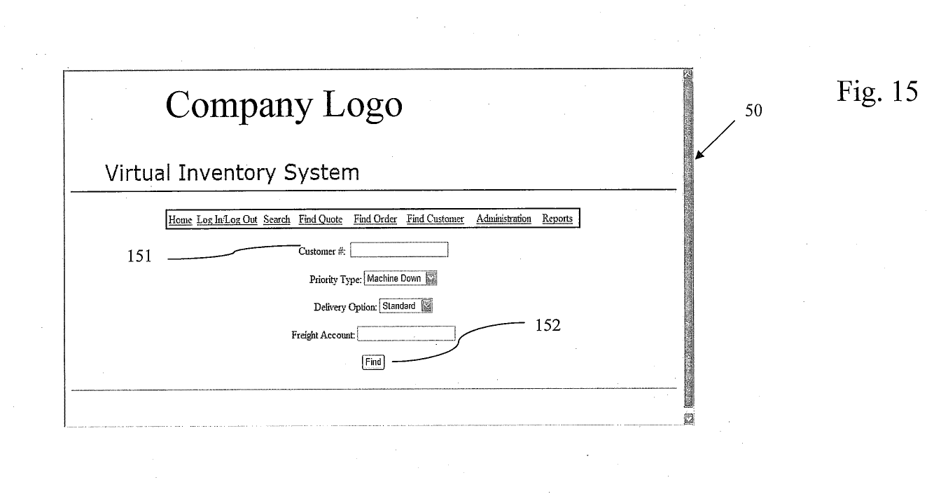

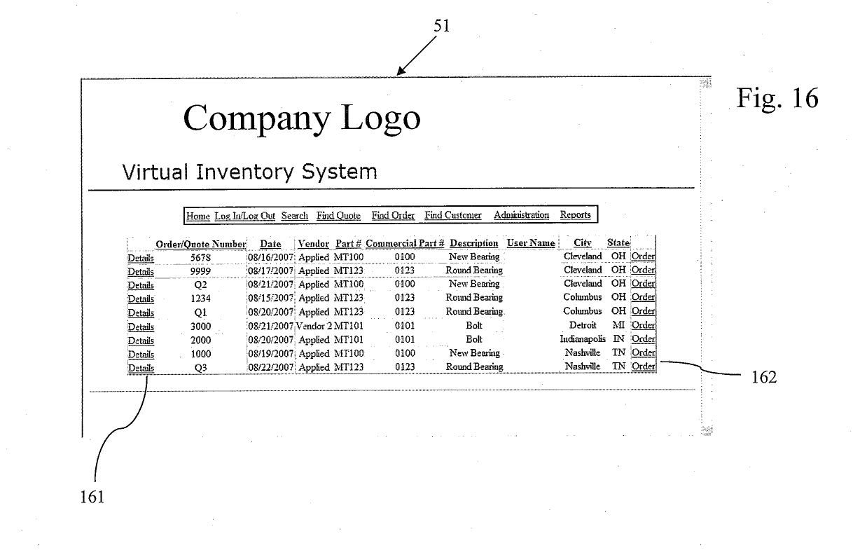

A User has the further option to search for previously entered quotes or orders by using a Find by Customer page 50, as illustrated in FIG. 15. The User inputs strings into the desired search fields, such as a customer number field 151. By clicking a Find by Customer button 152, the virtual inventory system software 6 will take the values from any or all of the search fields and combine them with an “and” operator to search for previously entered quotes/orders for any matches. The User is then redirected to a Find by Customer Results page 51, as illustrated in FIG. 16, where the User is presented with all of the previously recorded quotes and/or orders matching the entered search criteria.

The Find by Customer Results page 51 contains much of the same information that is found on the Search Results page 22. According to the illustrated embodiment, the Find by Customer Results page 51 contains a Details link 161, the order/quote number, date of the order/quote, vendor, party number, commercial part number, description, user name, city, and state. Order link 162 is also included on the results rows where quote information is given. Clicking a Details link 161 passes the quote or order number to the Inventory Details page 23 to display all of the information on the quoted or ordered part. Clicking on a Order link 162 takes the User to the Enter Order page 25 to convert the quote into an order. The link should include the quote information so that as many fields as possible on the Enter Order page 25 can be pre-populated.

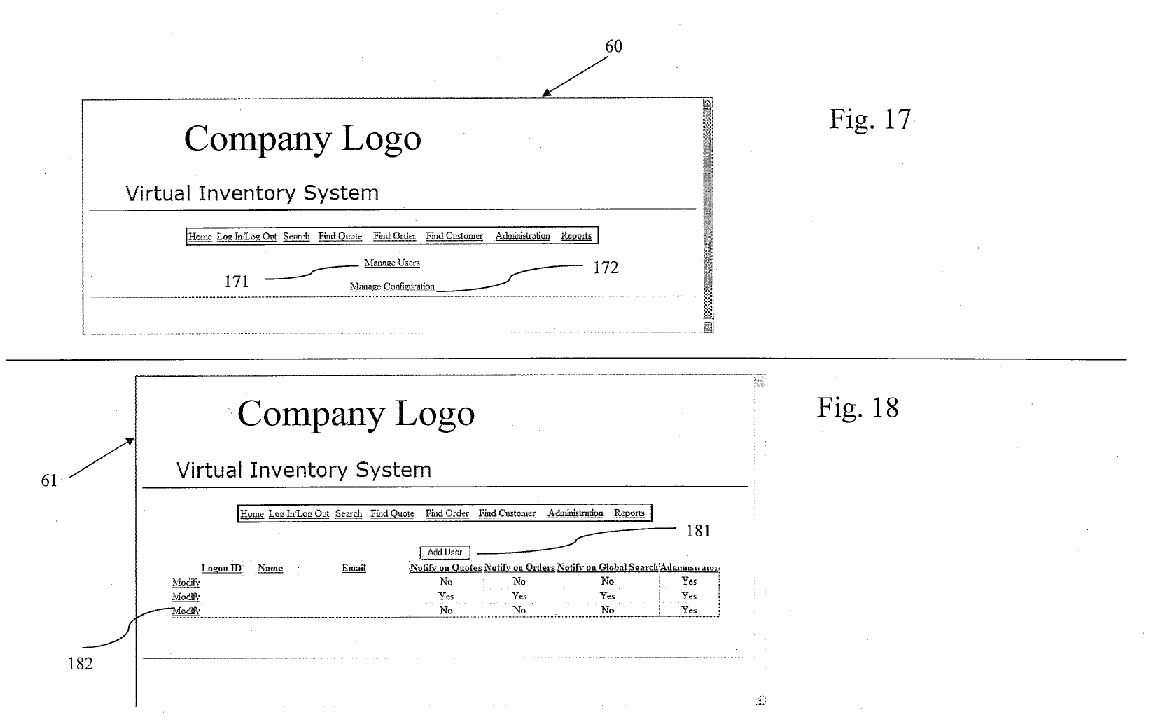

Reference is now made to FIGS. 17-21. Yet another option to the User is an Administration page 60. Users having an Administrator role typically access this page. The Administration page 60 gives the User complete control over the administration of the virtual inventory system 1, such as the ability to adjust the pricing terms, multipliers, email addresses, login information, and passwords. The Administration page 60 includes a Manage Users link 171 and a Manage Configuration link 172. Clicking on the Manage Users link 171 will take the User to a User Administration page 61, and clicking on Manage Configuration link 172 will take the user to a Configuration Administration page 64.

The User Administration page 61, shown in FIG. 18, is available to users with Administrator privilege. The User Administration page 61 displays a list of all current users, and the User can either choose an Add User button 181 or a Modify link 182. Selecting the Add User button 181 redirects the User to a User Maintenance page 62 so that a new user can be defined. Selecting the Modify link 182 redirects the user to the User Maintenance page 62 with the currently selected user's information populated.

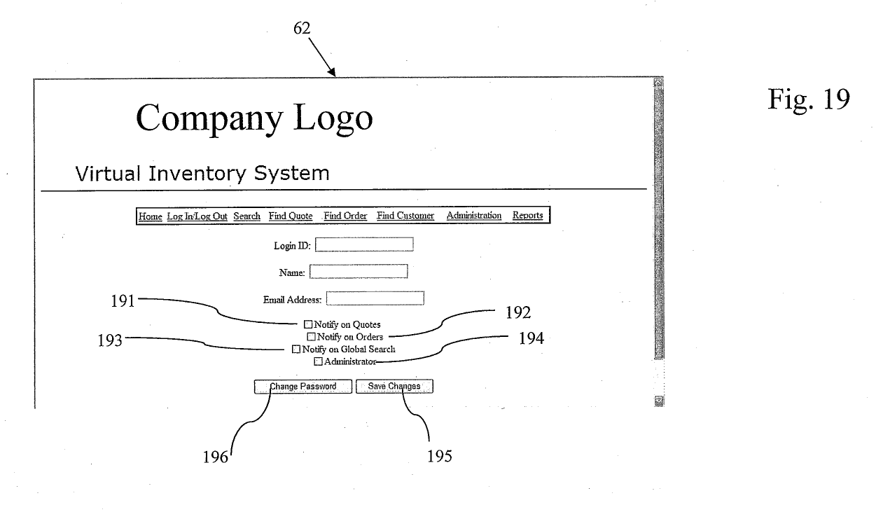

As illustrated in FIG. 19, the User Maintenance page 62 allows for creation and/or modification of a user's login ID, name, email address, and system roles, such as Notify on Quotes 191, Notify on Orders 192, Notify on Global search 193, and Administrator 194. The User Maintenance page 62 also includes a Save Changes button 195 and a Change Password button 196. Various roles can be selected for any given user. The Notify on Quotes role 191 will designate that all emails sent from the Enter Quote page 24 are sent to specified users. The Notify on Orders role 192 will designate that all emails sent from the Enter Order page 25 are sent to specified users. The Notify on Global Search role 193 will designate that all emails sent from the Global Search page 26 are sent to specified users. As discussed above, the Administrator role 194 will allow the User to add new users and modify the settings of current users for that particular client. As further discussed below, a user designated with the Administrator role also has the option to access the Reports page 70. After the appropriate information has been entered, the User can then click the Save Changes button 195 that will either add the new user or update the data for the existing user. Also, the User can choose the Change Password button 196 that will redirect the User to a page where the user's password can be reset.

The Configuration Administration page 64 allows a user with an Administrator role to set new values for configuration parameters. In one form, the virtual inventory system software 6 will default to an Expedite Multiplier and a Non-Standard Part Multiplier. The Expedite Multiplier is used to add to the vendor cost field when a part is on the customer's standard price list, but the margin between the vendor cost and the standard price list is not sufficient. In that case, the Sale Price is adjusted by the Expedite Multiplier. In the case of the Non-Standard Part Multiplier, this value is used when a part is located but does not exist on the standard price list. In that case, the Non-Standard Part Multiplier is applied to the vendor cost. The Configuration Administration page 64 includes a Modify Configuration link 201. Choosing the Modify Configuration link 201 redirects the User to a Configuration Maintenance page 65. The Configuration Maintenance page 65, shown in FIG. 21, allows a User with Administrator access to define or modify the values of configuration parameters.

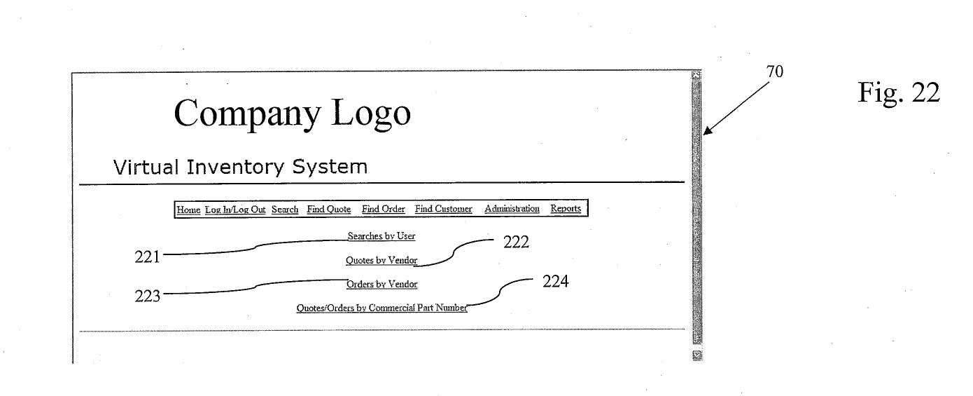

Referring now to FIG. 22, a further option exists for a User with an Administrator role: a Reports page 70. The Reports page 70 allows the User to view a variety of usage reports. As illustrated, the Reports page 70 includes a Searches by User report 221, a Quotes by Vendor report 222, an Order by Vendor report 223, and a Quotes/Orders by Commercial Part Number report 224. The User can select the Searches by User report 221, which prompts the User to input a data range and a particular user. The User is informed of the number of searches performed by the particular user. The User can also select the Quotes by Vendor report 222. Here, the User is prompted to enter a date range and a vendor, and a report is generated containing a list of quotes for each vendor including the number of quotes associated with that vendor. The User can select an Order by Vendor report 223. Again, the User is prompted to enter a date range and a vendor, and a report is generated containing a list of orders for each vendor including the number of orders associated with that vendor. Lastly, the User can select Quotes/Orders by Commercial Part Number report 224. The User is prompted to enter a date range and Commercial Part number, and a report is generated containing a list of all quotes and orders for that part by vendor. It is contemplated that these reports are available to the User in a form for easy viewing and capable of being saved locally on User computer 2.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for implementing a virtual inventory system, comprising the steps of:
receiving at a web server a product search request from a user computer system, said web server communicatively connected with a plurality of vendor databases, said product search request comprising at least one parameter, said web server separately maintained from said user computer system;
transmitting information related to said user from said web server to a database, said database configured to receive said user information and transmit user specific search instructions;
receiving at said web server said search instructions from said database;
searching said plurality of vendor databases pursuant to said search instructions and said at least one parameter; and
retrieving at said web server the results of said search.

2. The method of claim 1, further including the steps of
determining at said database a subset of said vendor databases associated with said user, said search instructions including said subset; and
searching each database of said subset of said vendor databases pursuant to said at least one parameter.

3. The method of claim 2, wherein said at least one parameter includes a part number.

4. The method of claim 2, wherein said at least one parameter includes a part description.

5. The method of claim 2, further including the step of processing said subset through a vendor hierarchy filter.

6. The method of claim 2, further including the step of processing said subset through a regional intelligence filter.

7. The method of claim 1, further including the step of visually depicting said results to said user.

8. The method of claim 5, wherein said results are visually depicted on a computer monitor within said user computer system.

9. The method of claim 1, wherein said searching step is performed through an XML connection.

10. The method of claim 1, wherein said retrieving step is performed through the fetching of batch files from said vendor database.

11. A virtual inventory system for the searching of products within the inventory of a vendor by a user, said system comprising:
a computer system associated with said user;
a web server communicatively connected to user computer system, said web server separately maintained from said user computer system, said web serving implementing a virtual inventory software;
a database server interfaced with said web server, said database server storing user settings specific to said user; and
a plurality of vendor inventory databases interfaced with said web server;
wherein said user must be logged into said web server via an internet connection to access said virtual inventory software,
wherein said web server is configured to receive a product search request from said computer system, and
wherein said web server is configured to search said plurality of inventory databases pursuant to said product search request.

12. The system of claim 11, wherein said user settings include a subset of said plurality of vendor inventory databases associated with said user.

13. The system of claim 12, wherein said database is configured to instruct said web server to search said subset of said plurality of vendor inventory databases.

14. The system of claim 11, wherein said web servers runs on IIS utilizing the .net framework.

15. The system of claim 11, wherein said database server runs on an SQL server.

16. The system of claim 11, wherein said web server is configured to search at least one of said plurality of inventory databases through an XML connection.

17. The system of claim 11, wherein said web server is configured to search at least one of said plurality of inventory databases through fetching batch files from said at least one of said plurality of inventory databases.

18. The system of claim 11, wherein said web server includes a presentation layer, said presentation layer containing the inventory data gathered from said search of said plurality of inventory databases.

19. The system of claim 11, wherein said web server includes a business layer, said business layer maintaining said virtual inventory software.

20. The system of claim 19, wherein said virtual inventory software comprises a vendor hierarchy filter.

21. The system of claim 19, wherein said virtual inventory software comprises a regional intelligence filter.
